(19) United States
(12) Patent Application Publication
(10) Pub. No.: US 2006/0056324 A1
(43) Pub. Date: Mar. 16, 2006

(54) Apparatus and method to provide mobile music appliance with subscription-based play-list service

(75) Inventors: Timo Hyyppa, Espoo (FI); Juha Salo, Littoinen (FI); Toni Kopra, Vantaa (FI); Mikko Makipaa, Helsinki (FI); Jukka Nihtila, Espoo (FI); Oren Haim Levine, Waltham,, MA (MA); Janne Aaltonen, Turku (FI); Ari Pajusalo, Helsinki (FI); Ahti Muhonen, Hirvivaara (FI); Ari Hannikainen, Lempaala (FI); Janne Antola, Laitila (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/937,944

(22) Filed: Sep. 10, 2004

(51) Int. Cl. H04B 7/00

(52) U.S. Cl. 370/310

(57) ABSTRACT

Disclosed is a method to deliver a set of song-related information to a terminal associated with a subscriber of a content provisioning system. The method includes establishing a subscriber profile for specifying at least a frequency at which the content provisioning system is to download to the subscriber at least one list of content, in the preferred invention at least one list of songs, that is updated in accordance with at least one criterion. The method further downloads the at least one song list to the terminal at a time that is based on the subscriber profile. Also disclosed is a content provisioning system, a network server and a terminal that operate in accordance with the method.

### TECHNICAL FIELD

This invention relates generally to the field of digital music services and servers and mobile music appliances, and mores specifically relates to digital music services, servers and appliances in the context of telecommunications and Internet service technologies.

### BACKGROUND

Digital music purchases over the Internet are currently growing in frequency and volume. Licenses for digital downloading of music content have become available from copyright owners and several services, including iTunes (a Trademark of Apple Computer) and Rhapsody (a Trademark of RealNetworks, Inc.), are currently in operation. While most of these services are used through a Personal Computer (PC), mobile Over-The-Air (OTA) download services have also been introduced. In general, these music download services may be referred to as play-list services.

However, at present at least a mobile OTA-based subscription to play-list services may be problematic. For example, browsing, previewing, purchasing, downloading and managing individual songs and a collection of same can be a complicated and expensive process when using the typically limited user interface of a mobile terminal. Further, the user interface and the actual music file download can be a slow experience over a typical cellular network, especially for a user who is accustomed to the much quicker response of a high speed wired Internet connection that is possible with a PC-based user interface.

Relatedly, browsing, searching and purchasing songs (associated with some user-defined play-list) over a relatively slow and potentially less reliable radio connection may be objectionable for some users. Further, it may be costly and time consuming to OTA-download a set or collection of songs belonging to some user-defined play-list. In addition, it can be difficult to manually manage the collection of downloaded songs, such as to always have at the disposal of the user in the mobile terminal the latest hit songs.

In commonly owned U.S. Patent Application Publication U.S. 2003/0045273 A1, Seppo Pyhalammi et al. describe a mobile content delivery system that optimizes the delivery of bandwidth-consuming content (or the flow of any peak-hour data traffic) in a way that best utilizes the free capacity in a radio network, thus enabling considerably more efficient usage of the radio capacity. The system also allows new services and pricing structures to be used in the cellular network, than otherwise would be possible. The class of delivery of message content can be selected by the user on a transaction basis, or it can be subscription-based and pre-defined in a user profile. By choosing a scheduled delivery the user can receive the content at a fraction of the price compared to instant delivery, since the content is sent at a time when the network is least utilized. The use of this technique for video files and for MP3 music audio files is said to especially beneficial.

While well suited for its intended and other purposes, the technique of Pyhalammi et al. does not adequately address all of the concerns and issues that were discussed above.

### SUMMARY OF THE PREFERRED EMBODIMENTS

The foregoing and other problems are overcome, and other advantages are realized, in accordance with the presently preferred embodiments of these teachings.

In one aspect this invention provides a method to deliver a set of content-related information to a terminal associated with a subscriber of a content provisioning system. The method includes establishing a subscriber profile for specifying at least a frequency at which the content provisioning system is to download to the subscriber at least one content list that is updated in accordance with at least one criterion; creating at least one rights object; and downloading the at least one content list to the terminal at a time that is based on the subscriber profile. In a preferred yet non-limiting embodiment the content list includes a song list.

In another aspect this invention provides a system that includes a content provisioning system and at least one terminal associated with a subscriber of the content provisioning system. In a non-limiting embodiment the system has a user interface to establishing a subscriber profile for specifying at least a frequency at which the content provisioning system is to download to the subscriber at least one song list that is updated in accordance with at least one criterion; a rights management subsystem operable to create any required rights objects; and a download subsystem to download the at least one song list to the terminal at a time that is based on the subscriber profile.

In a further aspect this invention provides a network server that forms at least a part of a content provisioning system. The server comprising a subscription subsystem that is responsive to information received from a terminal associated with a subscriber of the content provisioning system, to establish a subscriber profile for specifying at least a frequency at which the content provisioning system is to download to the subscriber at least one list of content that is updated in accordance with at least one criterion; a rights management subsystem operable to create and deliver any required rights objects; and a download subsystem to download the at least one list of content to the terminal at a time that is based on the subscriber profile. The list of content is, in the presently preferred but non-limiting embodiment, a list of songs.

In a still further aspect this invention provides a terminal associated with a subscriber to a content provisioning system. The terminal includes a transceiver for communication with the content provisioning system, a user interface, a content provisioning system subscription application, a content application, a content download manager coupled to the transceiver and a rights management subsystem for downloaded content. The user interface is operable to establish a subscriber profile for specifying at least a frequency at which the content provisioning system is to download to the subscriber at least one list of content that is updated in accordance with at least one criterion. The rights management subsystem cooperates with a content provisioning system, via the transceiver, to create at least one rights object for the downloaded content. The download manager is operable to receive the at least one list of content at a time that is based on the subscriber profile.

In a presently preferred yet non-limiting embodiment of the invention there is one digital rights management (DRM) rights object (RO) for an entire list of content. The list of content is downloaded in response to a download request from the download manager and comprises a list of URLs (that identify to the content download manager what content to download) and a URL of a Rights Issuer including the content list ID which makes it possible to fetch the content list related single Rights Object from the Rights Issuer database. The URLs in the content list point to download descriptor (DD) files used by the download manager to initiate a download sequence of the actual DRM protected content files (DCF). For the non-limiting case where there is one DRM RO for the entire list of content, it comprises contentIDs for all content (DCFs) in the content list.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a high level block diagram that illustrates the functional architecture of a Play-list downloading system in accordance with non-limiting embodiments of this invention;

FIG. 2 is another view of the system shown in FIG. 1, that shows in further detail Play-list downloading features;

FIG. 3 shows an exemplary play-list downloading and billing scenario in the context of the system block diagrams of FIGS. 1 and 2;

FIG. 4 shows one of the terminals of FIGS. 1 and 2, and illustrates certain Play-list content-related functions and components that are incorporated into the terminal;

FIG. 5 depicts an example of a Digital Rights Management (DRM) solution for the Play-list service;

FIG. 6 is a system diagram that is useful in explaining Play-list downloading with independent delivery of DRM protected content (DCF) items and Rights Objects (ROs); and

FIG. 7 illustrates the preferred embodiment of Play-list downloading interaction and message flow, in accordance with the independent delivery of DCF and RO as in FIG. 6.

### DETAILED DESCRIPTION OF THE PREFERRED EMBODIMENTS

The following list of definitions and abbreviations is useful when reading the following detailed description of the non-limiting and preferred embodiments of this invention.
Song A digital music file that may or may not include both instrumental and vocal tracks
Terminal A device capable of receiving and playing a song
Mobile Terminal A terminal capable of mobile use and operation including, but not limited to, a cellular telephone, a portable computer, a PDA, a dedicated music storage and playback appliance, each having a wireless interface, either a radio frequency (RF) or an infrared (IR) interface to a music content server
Fixed Terminal A terminal intended for non-mobile use, such as desktop PC, having either a wired or a wireless interface to the music content server
Play-list A play-list with a restricted number of songs, e.g., a TOP-TEN list
CMLA Content Management and Licensing Alliance
OTA Over the Air (Download)
OMA DRM 2 Open Mobile Alliance Digital Rights Management v.2
DLOTA OMA OTA Downloading
PrK Device Private Key according to OMA DRM 2
PuK Device Public Key according to OMA DRM 2
Dk Domain Key according to OMA DRM 2
REL OMA DRM 2 Rights Expression Language
RI Rights Issuer according to OMA DRM 2
CI Content Issuer according to OMA DRM 2
CA Certificate Authority
CDR Call Details Record, used as a standard billing information delivery format in telecom industry
OSCAR Online Certificate Status Protocol, one of two common schemes for maintaining the security of a server and other network resources. The other, older method, which OCSP has superseded in some scenarios, is known as Certificate Revocation List (CRL).
ROAP OMA DRM 2 Rights Object Acquisition Protocol
GW Gateway
HTTP Hypertext Transport Protocol
DL Download
DB Database
DD Download Descriptor according to OMA DLOTA specification
UI User Interface
WAP Wireless Application Protocol Suite
WLAN Wireless LAN

By way of introduction, the use of the non-limiting and preferred embodiments of this invention enables the scheduled downloading of musical content (also simply referred to as songs) at a desired time, such as during the night when charges may be lower. The use of the non-limiting and preferred embodiments of this invention may thus save access operator costs and potentially thus also subscriber's cost since, for example, a larger number of subscribers can be served when downloading at night, when other traffic (e.g., voice) is reduced.

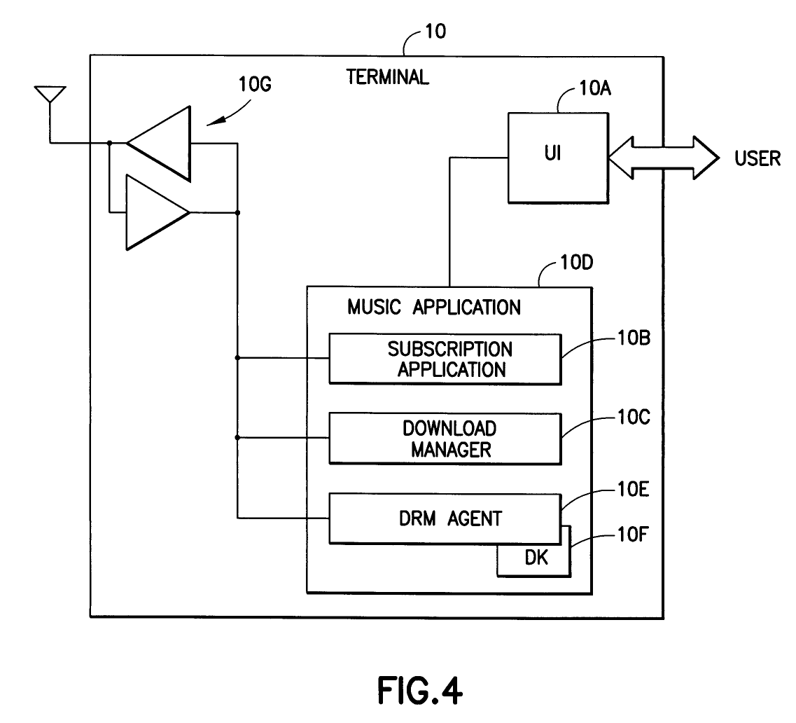

When using the music service the user can automatically receive in the user's music terminal up-to-date Play-lists that are updated according to user-defined time intervals (at a user-defined frequency). The music service makes it much simpler to preview and buy songs by adopting a subscription-based automated and straightforward method that is controlled by user preferences in a user subscription profile. The service may then offer different collections of songs to users in different Play-lists. One non-limiting example of a Play-list is a list of the top ten songs during a particular time period. In addition, since OMA DRM 2 is supported the user can subscribe the service to all of the user's terminals, including both mobile terminals and PCs, that belong to the user's accounted terminal domain (defined by the OMA DRM Domain Key, Dk (see FIG. 4, item 10F)). A further advantage is that the billing for services consumed by the user is automated.

The preferred, but non-limiting, embodiments of this invention are based on OMA DRM 2 and DLOTA open standards. OMA DRM 2 is currently widely accepted and required by the music industry as a music distribution copyright protection method.

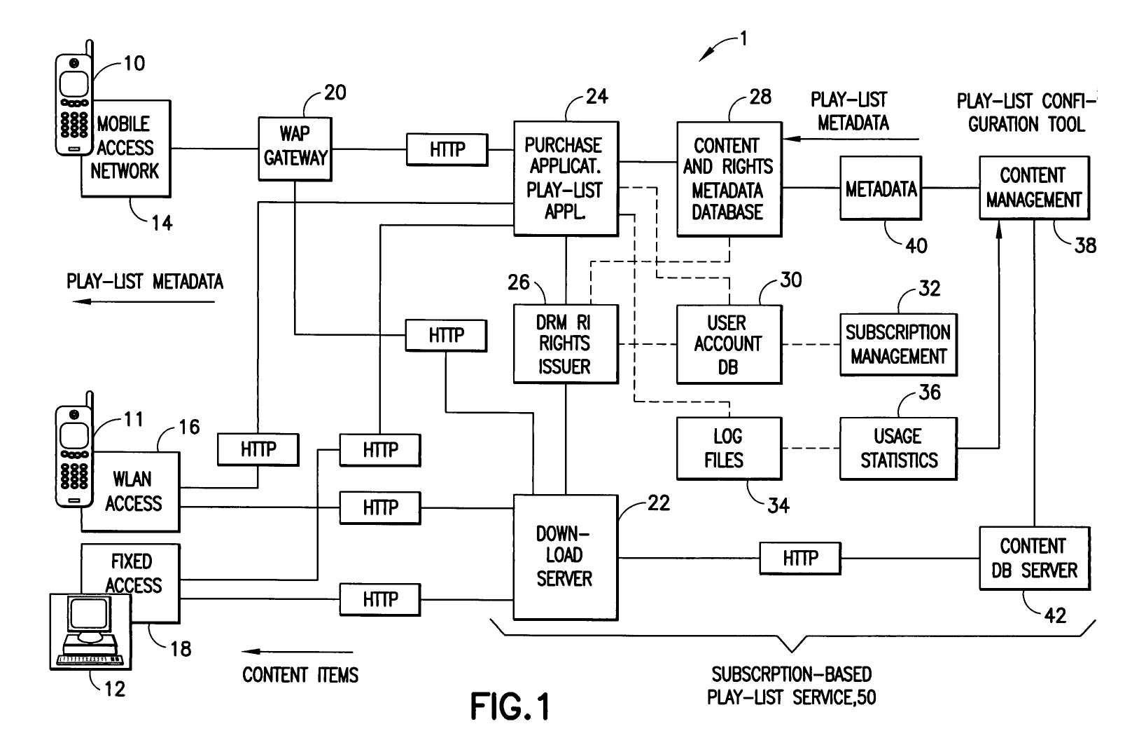

With regard to a basic OMA DRM 2 model, and as a non-limiting example, assume that a user purchases a song for her device (e.g., for one of the terminals 10, 11 or 12 of FIG. 1). The purchased song (i.e., the purchased content) cannot be listened to on any other device but the purchasing user's device. To achieve this goal the device acquires a Rights Object (RO) after completing the download of a protected content file (DCF=DRM Content File). The RO is encrypted with the private key of the device (PrK) or alternativly with an OMA DRM Domain key (Dk) in case the subscriber has registered multiple devices to the play-list service. In addition, the DCF is encrypted with a Content Encryption Key (CEK), which is within the RO's REL elements and is encrypted with the REK (Rights Encryption Key), and the REK is encrypted with the device's public key (PuK), or with the domain key (Dk) of the device domain where device has registered.

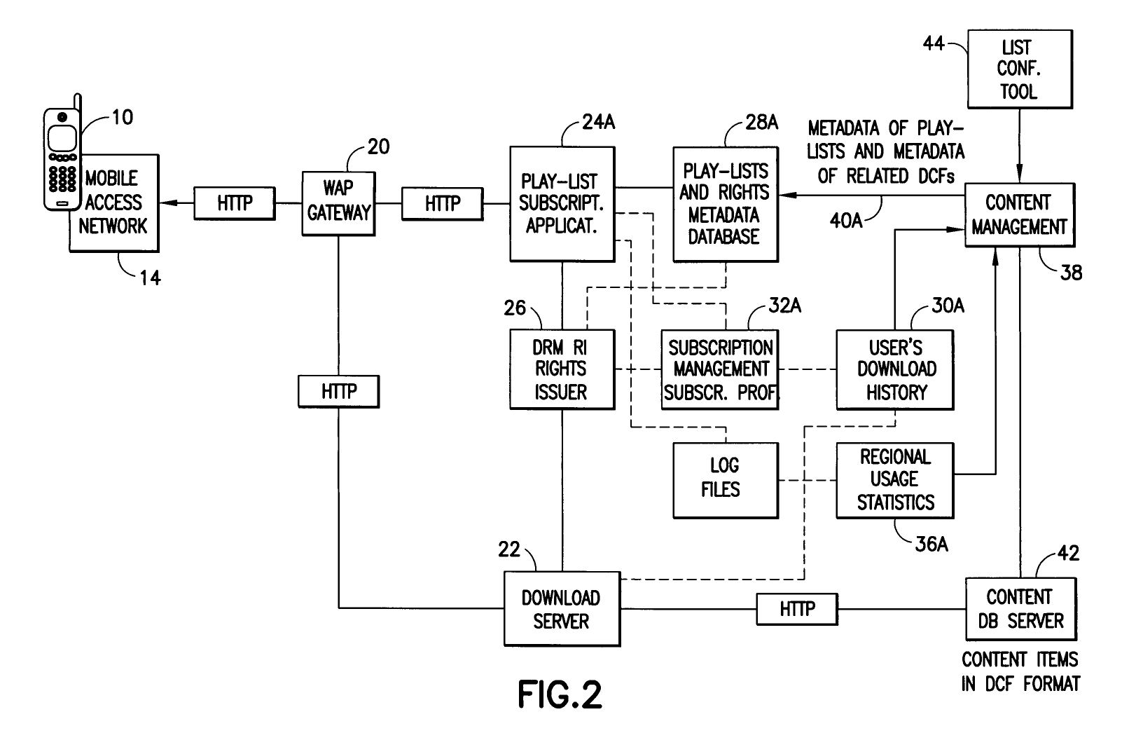

With regard to the metadata of the DCF for the Rights Issuer (RI) 26 of FIG. 1, the purpose of the RI metadata of the content is to transfer the required knowledge of the DRM protected content (DCF) from the Content Issuer's (CI) Content Management System 38 in FIG. 1, to the Content and Rights Metadata database 28A in FIG. 2. At a minimum, the RI metadata of the DCF associates the DCF ContentID with the encryption key used to encrypt the content, and may include also a hash value calculated over the DCF for integrity protection purposes. The RI metadata is used when creating the Rights Object (RO) for the Play-list DCFs in the RI 26.

The OMA DRM 2 specifications can be found at:
http://www.openmobilealliance.org/release_program/enabler_releases.html#DRM in the section “V2.0 Candidate”. Document OMA-DRM-DRM-V2_{—}0-20040716-C defines the protocols, messages, and mechanisms required to implement the DRM system. Document OMA-DRM-DCF-V2_{—}0-20040715-C defines the content format for DRM-protected media objects, which include encrypted content data and associated metadata. Document OMA-DRM-REL-V2_{—}0-20040716-C specifies the DRM Rights Expression Language, which describes usage rights for protected content in the OMA DRM system. The architecture of the OMA DRM system is described in document OMA-DRM-ARCH-V2_{—}0-20040715-C.

By way of introduction, a non-limiting Play-list service use case is now presented. Assume that a user subscribes to the Play-list service 50 of FIG. 1 and selects a Play-list that the user is interested in being updated on at regular intervals. The user receives a Play-list, e.g. Top Ten music tracks, on a regular basis (e.g., every week or every month). The user can listen to the Play-list, e.g. Top Ten songs, until the end of the update period. When downloading automatically (e.g., at night) the new Play-list, the current Play-list is compared in the terminal 10, 11 or 12, such as by the music application 10D, with the newly received Play-list, and the user is informed of any dropped list items (e.g. songs no longer appearing in the Top Ten list) the next time that the user uses the terminal's music application 10D. After a song is dropped from the Play-list (e.g., the Top Ten list), the rights to the track expire, however the user may purchase permanent rights for the dropped track. A precondition to the foregoing operations is that the user's OMA DRM 2 capable terminal 10, 11 or 12 has successfully registered to the Rights Issuer 26 via a ROAP protocol suite (via a ROAP Register message), and it has billing account established in the Play-list service 50.

Because of its inherent utility, the use of the presently preferred embodiments of this invention improve the profitability of the Music Service Provider, and reduce subscriber churn, as they provide a subscription-based service that employs user preferences and simplified and accurate billing. The billing process is preferably automated and provides flexibility regarding the methods of payment (e.g., operator-based billing and credit card-based billing). Overall, the user experience is improved through the use of automated processes controlled by the user preferences in the subscriptiom profile. Defined in the user's preferences can be a wide variety of information, such as preferred times for Play-list downloads to occur, time intervals between downloads, as well as preferred download bit rates, formats, and other factors that can affect price and/or performance. By the use of the non-limiting and preferred embodiments of this invention a play-list can be subscribed to for any of the terminals belonging to the user's DRM device domain (e.g., to both mobile terminals and PCs).

The creation of Play-lists can be automated, and may be based on user preferences, and/or on usage data and song user ratings collected by the music service system itself. A number of different play-lists can be subscribed to (e.g., Regional/Global Top Ten-lists according to, as non-limiting examples, usage statistics, user ratings and celebrity circulation lists). The existence of multiple play-list subscriptions per user are within the scope of the non-limiting and preferred embodiments of this invention.

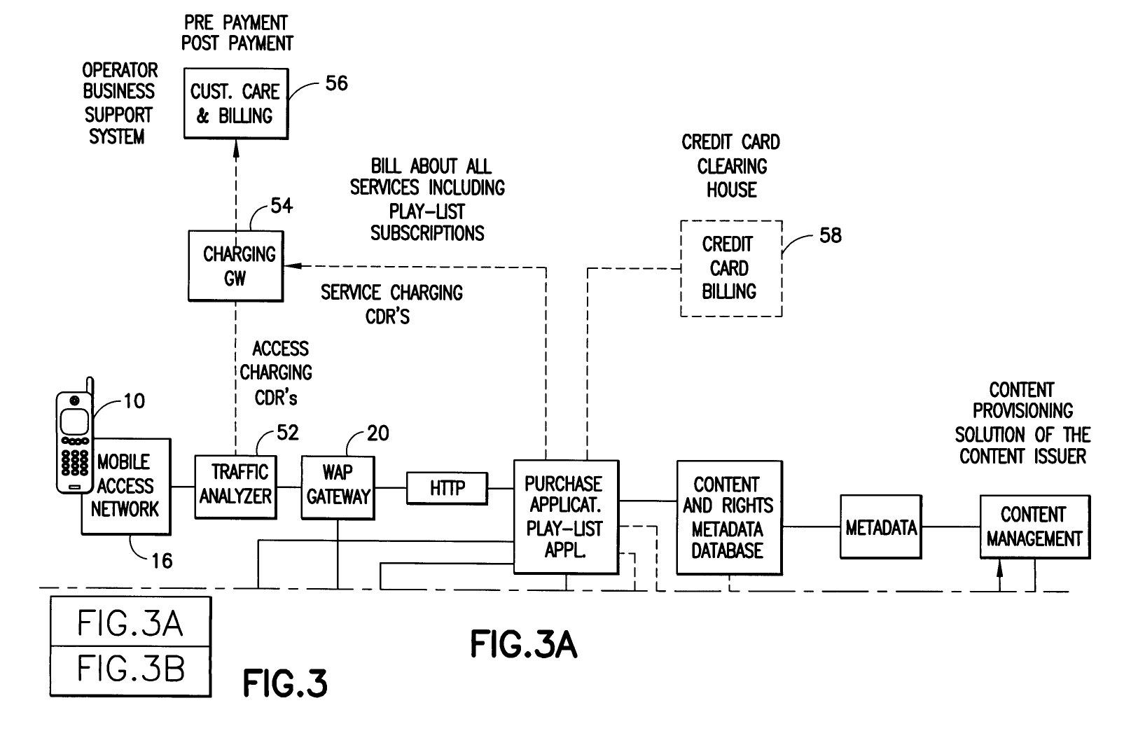

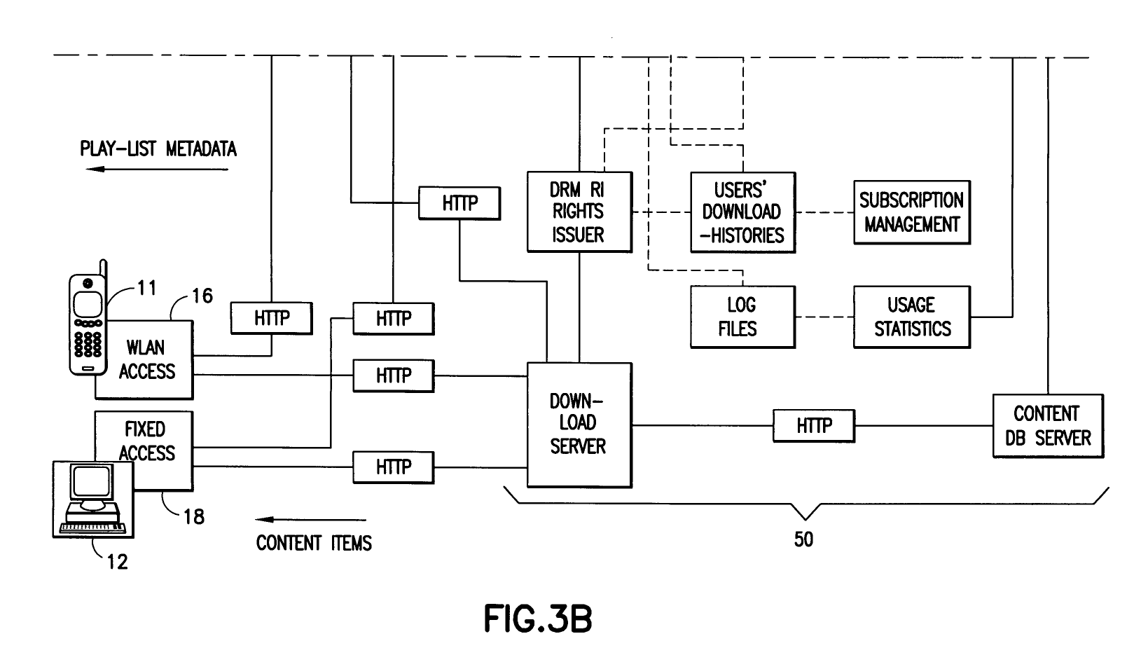

In general, the billing subsystem (elements 52, 54, 56, 58 in FIG. 3) automatically generates billing for the subscriber at least for maintaining and managing the subscription, as well as for accounting for purchased songs, and the possible use of the network resources, such as an amount of download bandwidth consumed, time of download, type of delivery (e.g., immediate or delayed, guaranteed or best effort), at least some of which parameters may be specified in the subscriber profile through the use of the user interface 10A.

The presently preferred and non-limiting embodiments of this invention may employ OTA downloading via a wide area network such as a cellular communications network, and may also employ and support, as examples, WLAN and fixed broadband access.

FIG. 1 is a high level block diagram that illustrates the functional architecture of a content provisioning system, also referred to herein as a Play-list downloading system or just system, in accordance with the non-limiting and preferred embodiments of this invention. The system is assumed to include a plurality of mobile terminals 10, 11, and possibly also fixed terminals such as a PC 12. Mobile terminal 10 is coupled to the system via a mobile access network 14, such as a cellular telecommunications network, while the mobile terminal 11 is coupled to the system via a WLAN access network 16. The WLAN access network 16 could be a Bluetooth network, a WiFi network, or any suitable local area network providing wireless connectivity. The mobile access network 14 may be coupled to a download server 22 via a WAP gateway 20. The WAP gateway 20, the WLAN access network 16, and a fixed access network 18 are assumed to have HTTP connectivity with the download server 22, and to also have HTTP connectivity with a (song) purchase/play-list application 24. All of the various links showing HTTP connectivity may be made in whole or in part through the Internet, and the download server 22 and purchase/play-list application 24, as examples, may be Internet servers. Both the download server 22 and the purchase/play-list application 24 are coupled to the above-mentioned DRM Rights Issuer (RI) block 26. Other components of the system include the content and rights metadata DB 28, a user account DB 30 coupled to a subscription management function 32, and log files 34 coupled to a usage statistics function 36. The usage statistics function 36 provides information to a content management function 38. The content management function 38 provides Play-lists metadata 40 to the content and rights DB 28, and is coupled to a content DB server 42 that in turn has HTTP connectivity with the download server 22. As is indicated in FIG. 1, the components and functions 22-42 collectively form a subscription-based play-list download service 50.

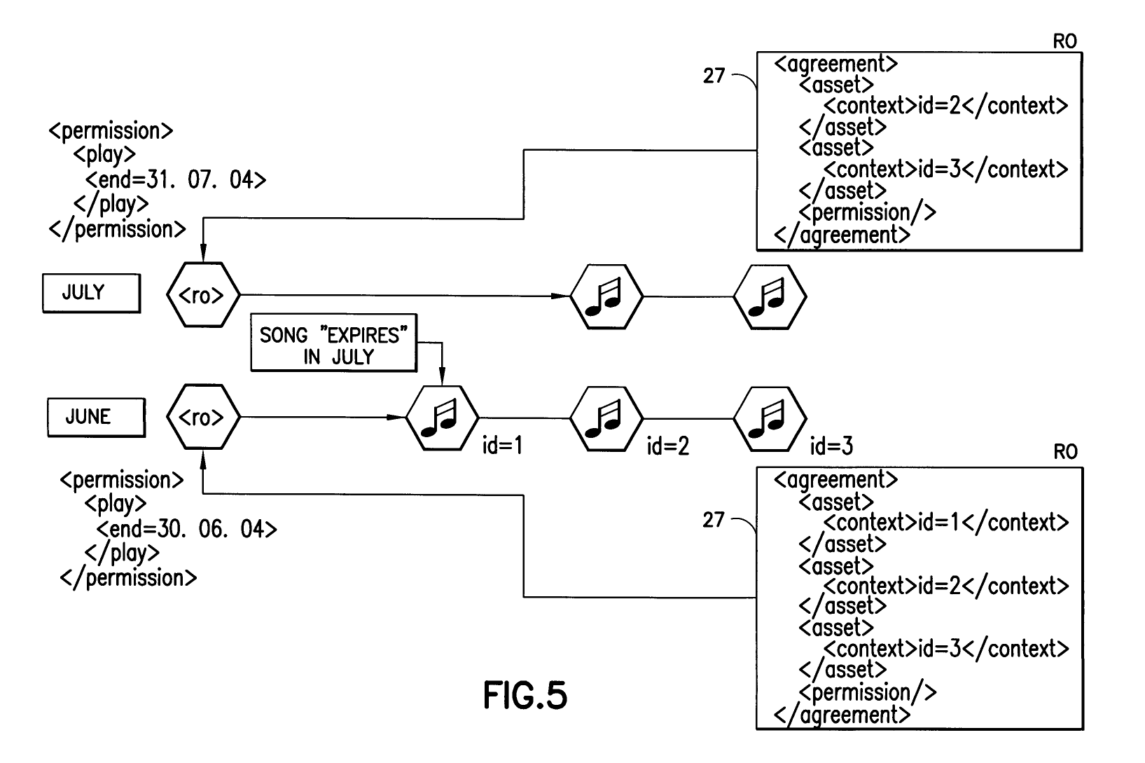

It is assumed that the terminals 10, 11, 12 include the following operational functions and components: a subscription application, a download manager, a music application and user interface, and an OMA DRM v. 2 agent (or equivalent) rights manager (see the description of FIG. 5 below). The presence of these components and functions makes it possible for the terminals 10, 11, 12 to interface to and interoperate with the system.

FIG. 2 is another view of the system shown in FIG. 1, that shows in further detail various content downloading functions and components that form a part of the Play-list download service 50. Certain of these functions and components are designated with an appended A to the reference number. More specifically the purchase/play-list application 24 of FIG. 1 is designated as the Play-list subscription application 24A; the content and rights metadata DB block 28 of FIG. 1 is designated as the Play-lists and Rights metadata DB 28A; the user account DB 30 is designated as the user's download history 30A and which can be seen to have a connection to the content management function 38; the subscription management function 32 is referred to as the subscription management with subscriber profiles 32A; the metadata 40 is designated as the metadata of Play-lists and metadata for RI of related DCFs, 40A; and the usage statistics function 36 is designated as the regional usage statistics function 36A. The use of regional information may be desirable, as songs belonging to, for example, a Play-list can easily vary between geographical regions. In FIG. 2 the content management function 38 is shown receiving input from a list configuration tool 44.

In FIG. 2, and referring also to FIG. 4, the user associated with the terminal 10, 11, 12 is assumed to employ the terminal UI 10A to subscribe to the Play-list service, and to create the subscriber profile that includes the user's preferences (such as a download schedule). The user is able to save downloaded songs to the user's local music collection according to preferred criteria in the subscription profile, such as automatically by genre, artist, or vocal versus instrumental, and/or to save the purchased songs manually to a preferred location.

As is shown in FIG. 4, in the terminal 10 are a subscription application 10B, a download manager 10C and a music application 10D. The above-mentioned user interface 10A can be used to, as non-limiting examples: display layouts, such as a new Play-list with newly added songs and dropped (deleted) songs; preview songs; purchase dropped songs; show download status; and manage the song catalog. Also in the terminal 10 is assumed to be a DRM Agent (rights manager) 10E that decrypts a rights object by using the Device Private key (PrK) or Domain Key (DK) 10F associated with the user's account when registering with the music service. The DRM Agent 10E checks the user's subscribed permissions defined by the Play-list RO for the DCFs belonging to the play-list as content items e.g. the subscription expiration time, rendering rights, and performs other OMA DRM 2 related tasks like processing of ROAP messages. All the terminal functions 10B, 10C, 10D, and 10E are coupled to a suitable terminal transceiver 10G, e.g. such as an RF cellular transceiver in the mobile access network-enabled mobile terminal 10. DRM Agent 10E, Subscription Application 10B and Download Manager 10C are used by the Music Application 10D as sub-functions when it communicates with the music service. The DRM Agent need not have a user interface.

It is noted that the terminal components and functions shown in FIG. 4 apply as well to the WLAN terminal 11 and to the fixed terminal 12. For example, in the fixed terminal 12 the transceiver 10G may be a wireless transceiver, or it may be a wired transceiver for coupling to, as examples, an Ethernet network or a DSL network. As such, hereafter a reference to the terminal 10 can be considered to be a general reference to the terminals 10, 111 and 12, unless otherwise indicated.

It is further noted that the terminal components and functions shown in FIG. 4 can be implemented in hardware, software, or in a combination of hardware and software. In the preferred embodiment many of the functions will be implemented as computer programs executed by a data processor that forms a part of the terminal 10. Note that at least some of these functions and blocks will have a hardware component, such as the user interface 10A, which may include a keypad or keyboard and a display, and the transceiver 10G that will contain circuitry, such as RF circuits, for at least the terminal 10 and 11 embodiments.

The subscription-based Play-list download service 50, specifically the Play-list subscription application 24A and the DRM RI 26 are operable to initialize Play-lists for the terminal 10, send on the terminal's request the download descriptors (DDs) of the DCFs belonging to the Play-list to the subscriber's terminal 10, create and send new subscription rights object with new validity time limits to the subscriber terminal 10, and to make billing CDRs for the subscription. The download server 22 is enabled to download Play-list items (e.g., Top Ten song DCFs) according to download descriptors (DDs) received from the terminal 10, which were created by the Play-list subscription application 24A, and to verify successful downloads, by receiving a delivery notification from the terminal 10, and to update the user's download history 30A accordingly.

The list configuration tool 44 shown in FIG. 2 can be used to create Play-lists with related metadata according to, for example, one or more criteria including consumption statistics and user ratings, celebrity circulation, or by other techniques and using other criteria as may be desired, such as location (e.g., city or country).

With regard to the actual Play-list download to the terminal 10, in the preferred embodiments of this invention the download request response contains a list of URLs that specify which files to download, and preferably also includes link to the page that should be displayed next in a browser based UI. The URLs in the list actually point to OMA OTA Download Descriptor files (DDs), which in turn initiate the controlled OMA DLOTA download sequence in the client application. The download URL-list file is preferably in, but is not limited to, the form of an XML file.

The root element for this XML document is <download-list>.

A non-limiting example of a download DD-URL list in XML is as follows:
<?xml version=“1.0” ?>
<download-list next-page=“list-songs.do?artistid=10”>
<file-to-get file-url=“http://dls/files/getdd.do?file=210”/>
. . . etc.
<file-to-get file-url=“http://dls/files/getdd.do?file=217”/>
</download-list>

The ‘file-to-get’ element describes the DD-file that is to be downloaded, and dls refers to the Download Server 22 in FIG. 1.

In a presently preferred but non-limiting embodiment of this invention the DD-URL list for every period (e.g., every user-specified period such as every month) includes all of the URLs for all songs in the Play-list (e.g., in a Top Ten-list). The client (e.g., user terminal 10) is responsible for identifying new and dropped content items (e.g., songs) based on the current (previously downloaded and stored) and new downloaded Play-lists. The terminal 10 modifies the DD-URL list for downloading of delta DCFs (new content items, not yet stored in the terminal 10). The Play list RO fetched by the DRM Agent 10E by using the Playlist identifier in the terminal contains all contentIDs of the DCFs belonging to the Play-list.

Further with regard to the DRM solution for the Play-list service 50 in accordance with the preferred embodiments of this invention, and referring to FIG. 5, the presently preferred DRM solution implements the Play-list service 50 (e.g., a Top Ten-list service) with a single terminal 10 Rights Object, that is, with a single device <ro>. The presently preferred DRM solution includes the contentIDs of all content (e.g,. songs) in the Play-list, and further issues a single RO 27 at start of each time period (such as once per month for the illustrated example). A number of advantages are realized by the use of this presently preferred DRM solution. For example, when a content item (e.g., a song) stays in the Play-list, there is no need to download the DCF again. Further, there can be a single RO 27 for all content items in the list (e.g., for all songs in the Play-list), and the use of the single RO 27 provides some level of group “identity”.

Note in FIG. 5 that in the RO 27 the <asset> elements specify the identity of the DRM Content governed by the containing <agreement> element via the <context> child element which specifies an identity (id) of the asset of interest (e.g., the song(s) of interest). Note that a <KeyInfo> element may provide functionality to access the DRM content if granted the rights to do so. See, in this regard, the above-mentioned DRM-related document: OMA-DRM-REL-V2_{—}0-20040716-C.

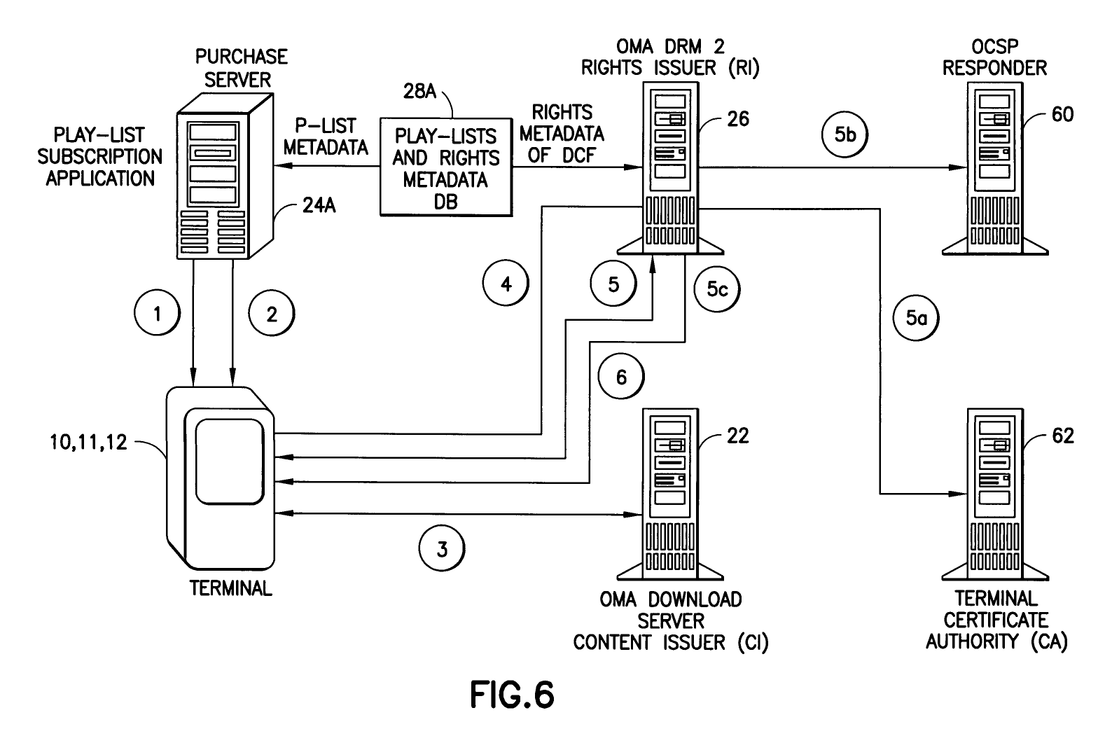

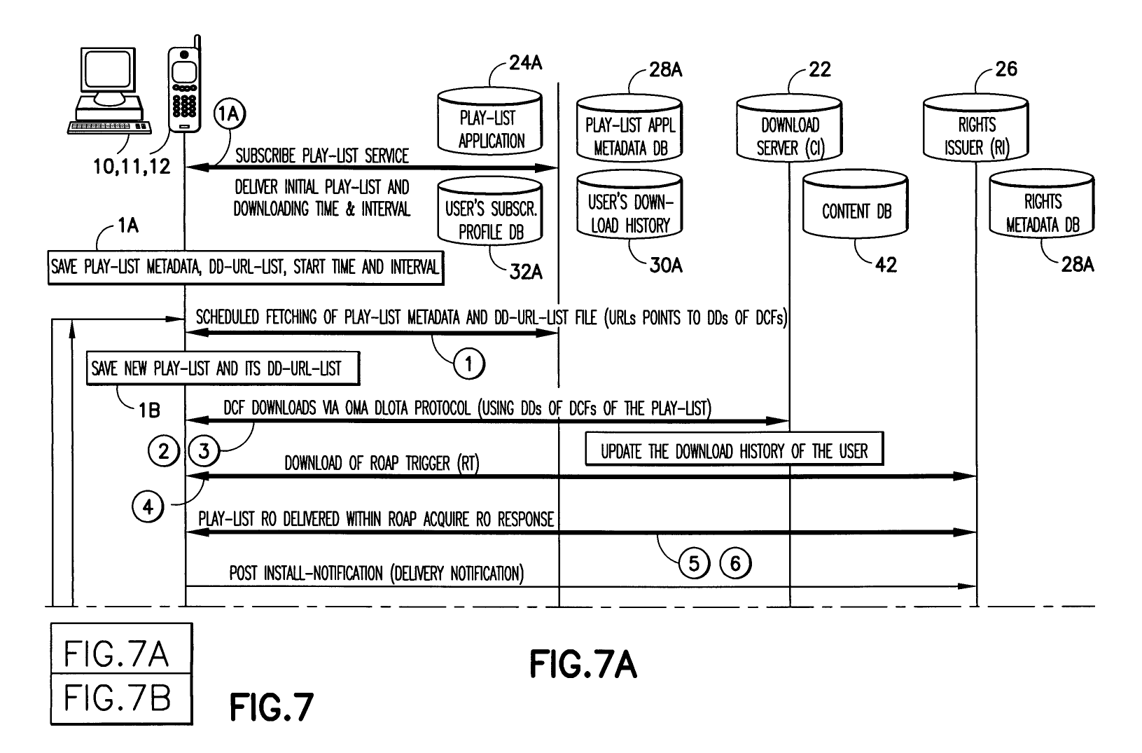

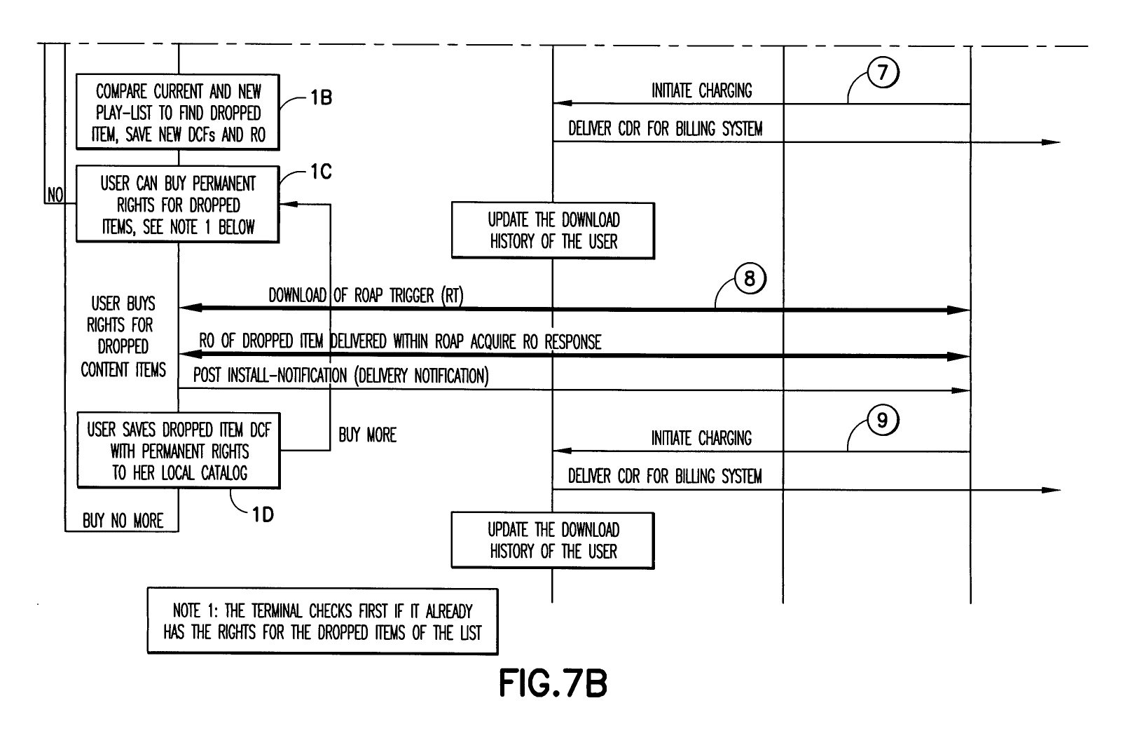

Reference is now made to FIGS. 6 and 7, where FIG. 6 is a system diagram that is useful in explaining Play-list downloading with independent delivery of DRM protected content (DCF) items and ROs, and where FIG. 7 illustrates preferred embodiment of Play-list downloading interaction and message flow, in accordance with the independent delivery of DCF and RO as in FIG. 6.

FIG. 6 shows various ones of the components of FIGS. 1 and 2, and also shows an OCSP Responder 60 and a terminal CA 62. Referring also to FIG. 7, at time 1 the terminal 10 acquires the Play-list metadata with the URL-list file (as explained above) of the DDs for the content items on the Play-list. This can be considered as a scheduled action. At time 2 the terminal 10 fetches download descriptors (DDs) for the DCFs defined by the Play-list URL-list file. At time 3 the terminal 10. downloads content: i.e., the content items (DCFs) of the Play-list, where the DCFs are the DRM-protected content items. At times 4, 5 and 6 messages flow between the terminal 10 and the OMA DRM RI 26, where the RI 26 is contacted to acquire Play-list rights (RO), and the RI 26 returns a ROAP Trigger (time 4), ROAP is started (time 5), and the RO of the Play-list is delivered (time 6). During time 5 various messages are sent between the RI 26 and the OCSP responder 60 and the terminal CA 62 and other actions are executed. The messages and actions include, but need not be limited to: at time 5a the terminal 10 certificate is verified with the terminal CA 62, at time 5b the RI 26 gets the RI verification information from the OCSP responder, at time 5c the RI 26 creates the Play-list RO with the stored DCF-Ids, key-information and hashes of the Play-list content items, having a RO format as indicated in RO block 27 of FIG. 5. At time 6 the RI 26 delivers the RO of the Play-list to the terminal 10, and at time 7 charging is initiated.

These activities are shown in FIG. 7 to be preceded at time 1A by the terminal 10 initially subscribing to the Play-list service 50, followed by the delivery of the initial Play-list and downloading of time and interval information. The terminal 10 is assumed to store this information in a suitable (persistent) memory (terminal action A1). In the illustrated interactions of FIGS. 6 and 7 the terminal 10 operates so as to schedule the downloading of Play-lists (during time 1A) and acquire temporary rights for the Play-list, store the current (or initial) Play-list data (activity 1A), compare the new Play-list and current (previously downloaded) Play-list (activity 1B), make and store the new Play-list as the current Play-list, and preferably provide the user with the opportunity to buy permanent rights for any content items that may have been dropped from the new Play-list as compared to the current Play-list (activities 1C and 1D). The buying of permanent rights for dropped content, assuming that the terminal 10 does not already have the permanent rights, involves the downloading of an additional ROAP trigger (time 8) and the delivery of the RO of the dropped content (time 9). This is followed, as is the delivery of the Play-list RO at time 6, by a delivery notification from the terminal 10 to the RI 26, and subsequent charging and billing operations conducted automatically in the Play-list service 50

As should be apparent, in this presently preferred embodiment of this invention the terminal 10 controls all downloading (Play-list, Play-list metadata, DCFs and ROs). The terminal 10 schedules the downloading, and compares the new Play-list to the current Play-list to identify dropped items. Further, the DRM solution assumes the use of but one RO 27 for the entire Play-list.

As should also be apparent, the presently preferred embodiments of this invention apply to many types of terminals, such as, but not limited to, those where the terminal comprises a digital content storage and playback device, where the terminal comprises a music storage and playback device, and where the terminal comprises a content storage for an image album and/or video and games catalog in addition to a playback device.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other similar, equivalent, or different digital rights procedures and rights objects may be employed, and content other than songs may be accommodated via Play-lists and user preference-based downloads, previews and purchases (such as image albums, video content and program lists and gaming content). However, all such and similar modifications of the teachings of the non-limiting and preferred embodiments of this invention will still fall within the scope of this invention.

Furthermore, some of the features of the present invention could be used to advantage without the corresponding use of other features. As such, the foregoing description should be considered as merely illustrative of the principles of the present invention, and not in limitation thereof.

1. A method to deliver a set of content to a terminal associated with a subscriber of a content provisioning system, comprising:
establishing a subscriber profile for specifying at least a frequency at which the content provisioning system is to download to the subscriber at least one list that is updated in accordance with at least one criterion;
creating at least one rights object; and
downloading the at least one content list to the terminal at a time that is based on the subscriber profile.

2. A method as in claim 1, where the content comprises songs, further comprising previewing at least one song that forms a part of a downloaded song list.

3. A method as in claim 1, where the content comprises songs, further comprising purchasing at least one downloaded song, and storing the purchased song in a collection of songs associated with the subscriber.

4. A method as in claim 1, where downloading occurs at least in part through a wireless cellular network.

5. A method as in claim 1, where downloading occurs at least in part through the Internet.

6. A method as in claim 1, where downloading occurs at least in part through a cellular communications network.

7. A method as in claim 1, where downloading occurs at least in part through a wireless local area network.

8. A method as in claim 1, where the criterion comprises a user preference e.g. location.

9. A method as in claim 1, where the criterion comprises content usage data.

10. A method as in claim 1, where the criterion comprises content ratings.

11. A method as in claim 1, where the content comprises songs, further comprising purchasing at least one downloaded song, and storing the purchased song in a collection of songs that is selected automatically based on at least one subscriber-preferred criterion.

12. A method as in claim 1, where the content comprises songs, further comprising purchasing at least one downloaded song, and storing the purchased song in a collection of songs that is selected manually by the subscriber.

13. A method as in claim 1, further comprising billing the subscriber automatically at least for maintaining and managing the subscription.

14. A method as in claim 1, where downloading comprises sending to the subscriber content list-related metadata.

15. A method as in claim 1, where downloading comprises sending to the subscriber Play-list related content.

16. A method as in claim 1, where there is one digital rights management (DRM) rights object (RO) for the entire content list.

17. A method as in claim 1, where the content list is downloaded in response to a download request and comprises a list of URLs that identify what files to download.

18. A method as in claim 17, where the URLs point to download descriptor (DD) files used by the terminal to initiate a download sequence.

19. A method as in claim 1, where there is one digital rights management (DRM) rights object (RO) for the entire content list, and comprises a contentIDs for all content in the content list.

20. A system comprising a content provisioning system and at least one terminal associated with a subscriber of the content provisioning system, comprising:
a user interface to establishing a subscriber profile for specifying at least a frequency at which the content provisioning system is to download to the subscriber at least one content list that is updated in accordance with at least one criterion;
a rights management subsystem operable to create at least one required rights object; and
a download subsystem to download the at least one content list to the terminal at a time that is based on the subscriber profile.

21. A system as in claim 20, where said terminal comprises functionality to preview at least one content that forms a part of the downloaded content list.

22. A system as in claim 20, where the content comprises songs, further comprising a purchasing application that cooperates with said terminal to purchase at least one song, and to store the purchased song in a collection of songs associated with the subscriber.

23. A system as in claim 20, where the download subsystem is coupled to the Internet.

24. A system as in claim 20, where the download subsystem is coupled to a cellular communications network.

25. A system as in claim 20, where the download subsystem is coupled to a wireless local area network.

26. A system as in claim 20, where the criterion comprises a user preference.

27. A system as in claim 20, where the criterion comprises content usage data.

28. A system as in claim 20, where the criterion comprises content ratings.

29. A system as in claim 20, where the content comprises songs, where a purchased song is stored in a collection of songs that is selected automatically based on at least one subscriber-preferred criterion entered through said user interface.

30. A system as in claim 20, where the content comprises songs, where a purchased song is stored in a collection of songs that is selected manually by the subscriber via said user interface.

31. A system as in claim 20, further comprising a billing subsystem to automatically generate billing for the subscriber at least for maintaining and managing the subscription.

32. A system as in claim 20, where said download subsystem sends content list related metadata to the subscriber.

33. A system as in claim 20, where said download subsystem sends content list related content to the subscriber.

34. A system as in claim 20, where there is one digital rights management (DRM) rights object (RO) for the entire content list.

35. A system as in claim 20, where the content list is downloaded in response to a download request and comprises a list of URLs that identify what files to download.

36. A system as in claim 35, where the URLs point to download descriptor (DD) files used by the terminal to initiate a download sequence.

37. A system as in claim 20, where there is one digital rights management (DRM) rights object (RO) for the entire content list, and comprises a contentIDs for all content in the content list.

38. A network server comprising at least a part of a content provisioning system, comprising:
a subscription subsystem that is responsive to information received from a terminal associated with a subscriber of the content provisioning system, to establish a subscriber profile for specifying at least a frequency at which the content provisioning system is to download to the subscriber at least one list of content that is updated in accordance with at least one criterion;
a rights management subsystem operable to download a list of content in association with a rights object for the list of content; and
a download subsystem to download the at least one list of content to the terminal at a time that is based on the subscriber profile.

39. A network server as in claim 38, further comprising a purchasing application that cooperates with said terminal to purchase content identified by said terminal.

40. A network server as in claim 38, where there is one digital rights management (DRM) rights object (RO) for the entire content list.

41. A network server as in claim 38, where the content list is downloaded in response to a download request from the terminal and comprises a list of URLs that identify what files to download.

42. A network server as in claim 41, where the URLs point to download descriptor (DD) files used by the terminal to initiate a download sequence.

43. A network server as in claim 38, where there is one digital rights management (DRM) rights object (RO) for the entire content list, and comprises a contentIDs for all content in the content list.

44. A network server as in claim 38, where the download subsystem is coupled to the Internet.

45. A network server as in claim 38, where the download subsystem is coupled to at least one of a cellular communications network and a wireless local area network.

46. A network server as in claim 38, where the criterion comprises at least one of a user preference, usage data, ratings and location.

47. A network server as in claim 38, further comprising a billing subsystem to automatically generate billing for the subscriber at least for maintaining and managing the subscription.

48. A network server as in claim 38, where the list of content comprises a list of songs.

49. A terminal associated with a subscriber to a content provisioning system, comprising a transceiver for communication with the content provisioning system, a user interface, a content provisioning system subscription application, a content application, a content download manager and a rights management subsystem for downloaded content, said user interface operable to establish a subscriber profile for specifying at least a frequency at which the content provisioning system is to download to the subscriber at least one list of content that is updated in accordance with at least one criterion; said rights management subsystem cooperating with a content provisioning system rights management subsystem, via said transceiver, to download at least one list of content in association with a rights object for the list of content; where said download manager is operable to receive the at least one list of content at a time that is based on the subscriber profile.

50. A terminal as in claim 49, where the content comprises songs, and where said user interface comprises functionality to preview at least one song that forms a part of the downloaded list of content.

51. A terminal as in claim 50, further comprising a purchasing application to purchase at least one song, and to store the purchased song in a collection of songs associated with the subscriber.

52. A terminal as in claim 49, where the transceiver is for coupling to the Internet.

53. A terminal as in claim 49, where the transceiver is comprised of an RF transceiver for coupling to a cellular communications network.

54. A terminal as in claim 49, where the transceiver is for coupling to a wireless local area network.

55. A terminal as in claim 49, where the criterion comprises at least one of a user preference, usage data, ratings and location.

56. A terminal as in claim 51, where a purchased song is stored in a collection of songs that is selected automatically based on at least one subscriber-preferred criterion entered through said user interface.

57. A terminal as in claim 51, where a purchased song is stored in a collection of songs that is selected manually by the subscriber via said user interface.

58. A terminal as in claim 49, where said download manager receives content list related metadata from the content provisioning system.

59. A terminal as in claim 49, where the content is comprised of songs, and where said download manager receives song list related content from the content provisioning system.

60. A terminal as in claim 49, where there is one digital rights management (DRM) rights object (RO) for an entire list of content.

61. A terminal as in claim 49, where the list of content is downloaded in response to a download request from the download manager and comprises a list of URLs that identify to the download manager what files to download.

62. A terminal as in claim 61, where the URLs point to download descriptor (DD) files used by the download manager to initiate a download sequence.

63. A terminal as in claim 49, where there is one digital rights management (DRM) rights object (RO) for the entire list of content, and comprises a contentIDs for all content in the content list.

64. A terminal as in claim 49, where said terminal comprises a cellular telephone.

65. A terminal as in claim 49, where said terminal comprises a personal computer.

66. A terminal as in claim 49, where said terminal comprises a WLAN-enabled data processor.

67. A terminal as in claim 49, where said terminal comprises a WLAN-enabled communications device.

68. A terminal as in claim 49, where said terminal comprises a digital content storage and playback device.

69. A terminal as in claim 49, where said terminal comprises a music storage and playback device.

70. A terminal as in claim 49, where said terminal comprises a content storage for image album and/or video and games catalog plus a playback device.

71. A computer program product comprising a computer useable medium including a computer readable program, wherein the computer readable program when executed on the computer causes the computer to perform operations comprising:
establishing a subscriber profile for specifying at least a frequency at which the content provisioning system is to download to the subscriber at least one list that is updated in accordance with at least one criterion;
creating at least one rights object; and
downloading the at least one content list to the terminal at a time that is based on the subscriber profile.

72. A computer program product as in claim 71, where the content comprises songs, further comprising previewing at least one song that forms a part of a downloaded song list.

73. A computer program product as in claim 71, where the content comprises songs, further comprising purchasing at least one downloaded song, and storing the purchased song in a collection of songs associated with the subscriber.

74. A computer program product as in claim 71, where downloading occurs at least in part through a wireless cellular network.

75. A computer program product as in claim 71, where downloading occurs at least in part through the Internet.

76. A computer program product as in claim 71, where downloading occurs at least in part through a cellular communications network.

77. A computer program product as in claim 71, where downloading occurs at least in part through a wireless local area network.

78. A computer program product as in claim 71, where the criterion comprises a user preference.

79. A computer program product as in claim 71, where the criterion comprises content usage data.

80. A computer program product as in claim 71, where the criterion comprises content ratings.

81. A computer program product as in claim 71, where the content comprises songs, further comprising purchasing at least one downloaded song, and storing the purchased song in a collection of songs that is selected automatically based on at least one subscriber-preferred criterion.

82. A computer program product as in claim 71, where the content comprises songs, further comprising purchasing at least one downloaded song, and storing the purchased song in a collection of songs that is selected manually by the subscriber.

83. A computer program product as in claim 71, further comprising billing the subscriber automatically at least for maintaining and managing the subscription.

84. A computer program product as in claim 71, where downloading comprises sending to the subscriber content list-related metadata.

85. A computer program product as in claim 71, where downloading comprises sending to the subscriber Play-list related content.

86. A computer program product as in claim 71, where there is one digital rights management (DRM) rights object (RO) for the entire content list.

87. A computer program product as in claim 71, where the content list is downloaded in response to a download request and comprises a list of URLs that identify what files to download.

88. A computer program product as in claim 87, where the URLs point to download descriptor (DD) files used by the terminal to initiate a download sequence.

89. A computer program product as in claim 71, where there is one digital rights management (DRM) rights object (RO) for the entire content list, and comprises a contentIDs for all content in the content list.

90. A computer program product as in claim 78, where the user preference comprises location.
